(19) United States
(12) Patent Application Publication
(10) Pub. No.: US 2012/0170125 A1
(43) Pub. Date: Jul. 5, 2012

(54) LENS MODULE, LENS WAFER MODULE, AND METHOD OF MANUFACTURING LENS MODULE

(75) Inventor: Joon Hyuk HAN, Hwaseong (KR)

(73) Assignee: SAMSUNG ELECTRO-MECHANICS CO., LTD., Suwon (KR)

(21) Appl. No.: 13/338,697

(22) Filed: Dec. 28, 2011

(30) Foreign Application Priority Data
Dec. 29, 2010 (KR) 10-2010-0138340
May 24, 2011 (KR) 10-2011-0049035

(51) Int. Cl. G02B 7/02; B23P 11/00

(52) U.S. Cl. 359/601; 29/428

(57) ABSTRACT

There are a lens module and a lens wafer module. The lens module includes: a lens assembly including at least one lens stacked on an optical axis and a seating groove recessed in one surface of the lens; and a stopping part installed in the seating groove and blocking unnecessary light incident on the lens assembly.

### CROSS-REFERENCE TO RELATED APPLICATIONS

This application claims the priority of Korean Patent Application Nos. 10-2010-0138340 and 10-2011-0049035 filed on Dec. 29, 2010 and May 24, 2011, in the Korean Intellectual Property Office, the disclosures of which are incorporated herein by reference.

### BACKGROUND OF THE INVENTION

1. Field of the Invention

The present invention relates to a lens module, a lens wafer module, and a method of manufacturing the lens module, and more particularly, to a lens module, a lens wafer module, and a method of manufacturing the lens module ensuring the positional precision of a stopping part blocking unnecessary light incident through a lens.

2. Description of the Related Art

In recent years, technologies related to various readily portable mobile devices, having enforced voice information and data transmission and reception functions, have been rapidly developed and implemented. In particular, mobile terminals having a camera module mounted therein having a camera function able to capture and store moving and still images and transmit the images to counterparts by merging a camera module based on digital camera technology with a wireless portable communications terminal have been commercialized.

A camera module mounted in a small-sized portable terminal adopts a configuration for blocking unnecessary light incident through a lens, and a method of implementing such a configuration includes implementing the configuration in the lens or in a lens barrel into which the lens is inserted or a housing into which the lens barrel is inserted.

In the method of implementing the configuration in the lens, the configuration is implemented on the lens wafer or the top of glass by a deposition method or a printing method for a semiconductor process. This method has a problem in terms of cost in applying the semiconductor process, a precision problem in printing, and a limit in design such that one surface of the lens cannot be used as a lens functioning unit, and as a result, a loss of performance in an optical lens may be generated.

In the method of implementing the configuration in the component such as the lens barrel or the housing, since the positional precision of a light blocking component depends on the precision of the component, it may be difficult to ensure the performance thereof and in particular, since an array lens manufactured as a wafer unit has a quadrangular shape due to dicing, unlike in the case of a circular lens formed by a general injection molding, it may be difficult to match an optical axis of the light blocking component with that of the lens.

### SUMMARY OF THE INVENTION

An aspect of the present invention provides a lens module, a lens wafer module, and a method of manufacturing the lens module that can ensure the positional precision of a stopping part blocking unnecessary light incident through a lens to thereby improve the performance of the lens.

According to an aspect of the present invention, there is provided a lens module including: a lens assembly including at least one lens stacked on an optical axis and a seating groove recessed in one surface of the lens; and a stopping part installed in the seating groove and blocking unnecessary light incident on the lens assembly.

The seating groove may have a depth substantially identical to a thickness of the stopping part.

The stopping part may have a ring shape including an opening in a center thereof, the opening allowing light to pass therethrough.

The at least one lens may include a lens functioning unit and a flange unit forming a margin portion of the lens functioning unit.

The seating groove may be stepped from one surface of the flange unit.

The stopping part may include at least one bridge extending from an outer diameter thereof to an outer part of the at least one lens.

The seating groove may include an extension groove extending from the outer diameter of the stopping part to the outer part of the at least one lens to allow the at least one bridge to be installed therein.

The stopping part may be installed in a seating groove formed in an upper surface of an object-side lens among the at least one lens.

The stopping part may be installed in a seating groove formed in an upper surface of an image-side lens among the at least one lens.

The stopping part may include an adhesive unit along an outer diamter thereof, the adhesive unit being filled with an adhesive for fixing the stopping part.

According to another aspect of the present invention, there is provided a lens wafer module including: a lens wafer in which a plurality of lenses are arranged; and stopping parts installed in seating grooves recessed in one surface of the lens wafer, and including light blocking units blocking unnecessary light incident on the lenses and bridges making connections between the light blocking units of the individual lenses.

Each of the plurality of lenses may include a lens functioning unit and a flange unit forming a margin portion of the lens functioning unit.

The seating groove may be stepped from one surface of the flange unit.

According to another aspect of the present invention, there is provided a method of manufacturing a lens module, the method including: preparing a lens wafer in which a plurality of lenses are arranged; installing stopping parts blocking unnecessary light incident on the lenses in seating grooves recessed in one surface of the lens wafer; and cutting the lens wafer having the stopping parts installed therein into the individual lenses.

The installing of the stopping parts in the seating grooves of the lens wafer may be performed by separately installing the individual stopping parts in the respective lenses.

The installing of the stopping parts in the seating grooves of the lens wafer may be performed by installing a single sheet of the stopping parts including light blocking units and bridges connecting the light blocking units in the respective lenses.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic cross-sectional view showing the configuration of a camera module package including a lens module according to a first embodiment of the present invention;

FIG. 2 is a cross-sectional view showing the lens module according to the first embodiment of the present invention;

FIG. 3 is a perspective view of the lens module according to the first embodiment of the present invention;

FIG. 4 is a perspective view of a lens wafer according to the first embodiment of the present invention;

FIG. 5 is a perspective view of a lens wafer module according to the first embodiment of the present invention;

FIG. 6 is a schematic cross-sectional view showing the configuration of a camera module package including a lens module according to a second embodiment of the present invention;

FIG. 7A is a perspective view of the lens module according to the second embodiment of the present invention and FIG. 7B is a perspective view of a lens in a lens module according to another embodiment of the present invention;

FIG. 8 is a perspective view of a lens wafer according to the second embodiment of the present invention;

FIG. 9 is a perspective view of a lens wafer module according to the second embodiment of the present invention;

FIG. 10 is a perspective view of a lens module according to a third embodiment of the present invention;

FIG. 11 is a perspective view of a lens module according to a fourth embodiment of the present invention; and

FIG. 12 is a perspective view of a stopping part of the lens module according to the fourth embodiment of the present invention.

### DETAILED DESCRIPTION OF THE PREFERRED EMBODIMENT

Embodiments of the present invention will now be described in detail with reference to the accompanying drawings. The invention may, however, be embodied in many different forms and should not be construed as being limited to the embodiments set forth herein. While those skilled in the art could readily devise many other varied embodiments that incorporate the teachings of the present invention through the addition, modification or deletion of elements, such embodiments may fall within the scope of the present invention.

The same or equivalent elements are referred to by the same reference numerals throughout the specification.

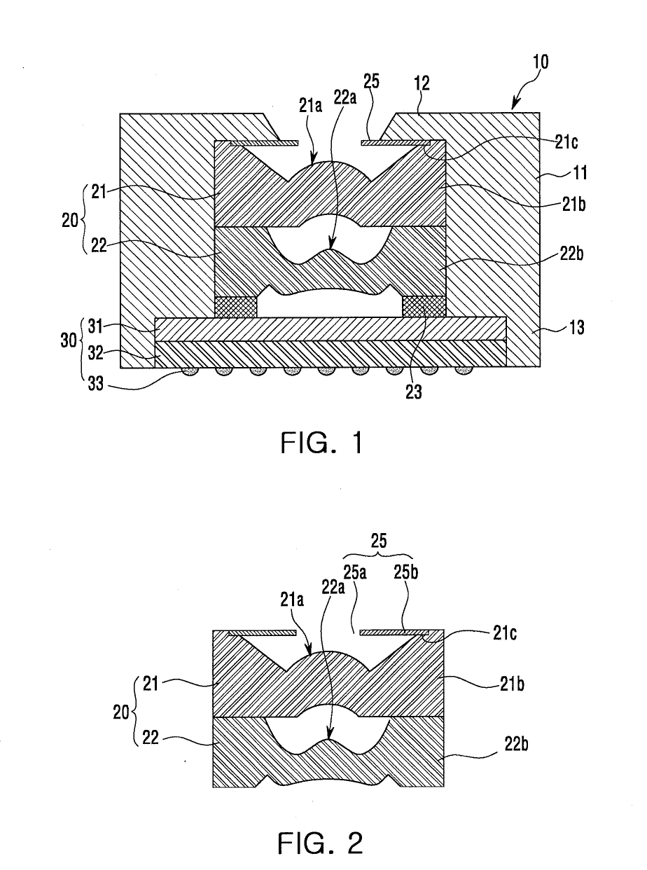

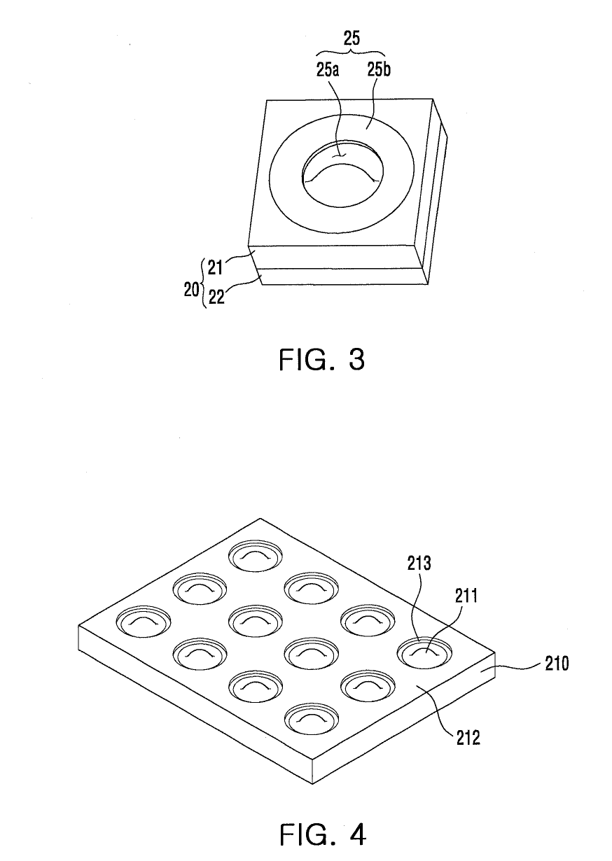

FIG. 1 is a schematic cross-sectional view showing the configuration of a camera module package including a lens module according to a first embodiment of the present invention, FIG. 2 is a cross-sectional view showing a lens module according to the first embodiment of the present invention, and FIG. 3 is a perspective view of a lens module according to the first embodiment of the present invention.

Referring to FIG. 1, the camera module package according to the first embodiment of the present invention includes a lens module 20 including at least one lens stacked on an optical axis, an image sensor module 30 receiving incident light from the lens, and a housing 10 housing the lens module 20 and the image sensor module 30.

Referring to FIG. 2, the lens module 20 includes a first lens 21 and a second lens 22 sequentially formed from an object side to an image side. The lens module 20 includes two lenses in this embodiment; however, the present invention is not limited thereto, and the lens module 20 may include two or more plural lenses.

The lens module 20 has a structure in which plural lenses are stacked in the present embodiment; however, the present invention is not limited thereto. The lens module 20 may have a structure in which plural lenses are assembled to be inserted into a lens barrel, and the structure of the lens module may be diversely changed according to a design condition.

The lens is formed of a spherical surface or an aspheric surface made of a transparent material to create an optical image by collecting or effusing light incident from an object. The lens includes a plastic lens and a glass lens. The plastic lens is formed by a resin inserted into a mold, pressed and cured, manufactured on a wafer scale, and thereafter, individualized. The plastic lens can be manufactured at low cost and manufactured in large quantities. The glass lens is advantageous in implementing high resolution, but since the glass lens is manufactured by cutting and grinding glass, the manufacturing process thereof may be complicated and high manufacturing costs may be incurred and it may be difficult to implement a lens having a shape other than a spherical shape or a planar shape.

In the present embodiment, the plastic lens manufactured in the wafer scale is used and the first and second lenses 21 and 22 include spherical or aspheric lens functioning units 21a and 22a at the centers thereof and further include flange units 21b and 22b forming the margin portions of the lens functioning units 21a and 22a.

The lens functioning units 21a and 22a may have various shapes such as a convex or concave shape toward the object side, a convex or concave shape toward the image side, or a concave shape at the center thereof toward the image side and a convex shape at the flange units toward the image side. Further, the flange units 21b and 22b may serve as spacers allowing the lens functioning units to be spaced apart from each other at the time of stacking adjacent lenses.

As shown in FIG. 1, a spacer 23, allowing a lens and an image sensor to be spaced apart from each other by a predetermined distance, may be installed between the lens module 20 and the image sensor module 30. The spacer 23 may allow an image to be formed in the image sensor by adjusting a focal length of the lens. Such an additional spacer member is used between the lens and the image sensor in the present embodiment; however, the present invention is not limited thereto, and the spacer may be formed integrally with the flange unit 22b of the second lens 22. That is, as described above, the spacer may be installed in various forms through various design modifications.

A stopping part 25, blocking unnecessary light incident on the lens module 20, may be installed on the upper surface of the first lens 21. The stopping part 25 may be fixedly inserted into a seating groove 21c recessed from the upper surface of the flange unit 21b of the first lens 21. The stopping part 25 may be fixed by using a thermosetting adhesive such as an epoxy.

The stopping part 25 includes a light blocking unit 25a blocking unnecessary light incident on the lens module 20 and an opening 25b allowing light to pass therethrough. That is, as shown in FIG. 3, the stopping part 25 may have a circular ring shape. The stopping part 25 may be made of a steel use stainless (SUS) material. Since the SUS material is resistant to heat, the stopping part 25 can be prevented from being deformed at the time of bonding the stopping part 25 when the SUS material is used.

In the state in which the stopping part 25 is installed, the seating groove 21c may have substantially the same depth as the thickness of the stopping part 25 such that the upper surface of the stopping part 25 and the upper surface of the flange unit 21b of the first lens 21 are positioned on the same horizontal surface. Therefore, the seating groove 21c may be stepped from the upper surface of the flange unit 21b by the thickness of the stopping part 25.

The stopping part 25 is installed on the upper surface of the first lens 21 in the present embodiment; however, the present invention is not limited thereto. The stopping part 25 may be installed on the lower surface of the second lens 22 or the lower surface of the first lens 21 or the upper surface of the second lens 22 between the first lens 21 and the second lens 22.

The image sensor module 30 may be a chip scale package (CSP) including an image sensor chip 32 including an image area where light passing through the lens module 20 is imaged.

The chip scale package (alternatively, a chip size package) is a new package type which has been developed and proposed in recent years and has more advantages than a general plastic package, the most attractive advantage of which is the package size itself. According to definitions by international semiconductor association such as the Joint Electron Device Engineering Council (JEDEC) and the Electronic Industry Association of Japan (EIAJ), the chip scale package is generally a name for a class of packages having an area no larger than 1.2 times as large as that of a chip. The chip scale package is generally used in products requiring miniaturization and portability, such as a digital camcorder, a cellular phone, a notebook computer, a memory card, and the like. Semiconductor elements such as a digital signal processor (DSP), an application specific integrated circuit (ASIC), a micro controller, and the like are mounted in the chip scale package. Further, the use of chip scale packages having memory elements such as a dynamic random access memory (DRAM), a flash memory, and the like mounted therein is being increased.

The image sensor chip 32 receives light and converts the received light into an electrical signal. The image sensor chip 32 may be classified into a charge coupled device (CCD) sensor chip and a complementary metal oxide semiconductor (CMOS) sensor chip according to the operation and manufacturing method thereof. The CCD sensor chip is based on an analog circuit and has a structure in which light incident on the lens module 20 is diffused to plural cells, each cell storing charge for the light, and a contrast level is judged based on the magnitude of the charge and thereafter, the judged contrast level is transmitted to a converting device to express a color. The CCD sensor chip can express a clear image quality, however, is large in a data storage capacity and power consumption. Therefore, the CCD sensor chip is more commonly used in a digital camera requiring high definition. The CMOS sensor chip is formed by integrating an analog signal processing circuit and a digital signal processing circuit in a semiconductor. The CMOS sensor chip has a rate of power consumption just 1/10 that of the CCD sensor chip, and since required parts are configured as a single chip, more miniaturized products can be manufactured. In recent years, with improvements in technology, since the CMOS sensor chip has even a high-definition function in addition to the above advantages, the CMOS sensor chip has been more widely used in various fields including a digital camera, a camera phone, a personal media player (PMP), and the like.

The image sensor chip 32 includes a wafer having an image sensor on the upper surface thereof. Further, the image sensor chip 32 includes a connection member 33 on the lower surface thereof mounted with a camera. The connection member 33 may be connected to a terminal of a main board (not shown) having a camera mounted therein.

The connection member 33 may be made of a conductive paste and specifically, may be made of a solder paste or an Ag-epoxy resin. Further, the connection member 33 may have the form of a solder ball.

A cover glass 31 may be formed on the upper surface of the image sensor chip 32, and one surface of the cover glass 31 is IR-coated to thereby serve as an infrared-ray (IR) blocking filter.

The IR blocking filter allows only a light signal of a visible light area to pass therethrough by removing a light signal of an infrared-ray area before the light signal is inputted into the image sensor through the lens, thereby acquiring an image having a color close to an actual color.

The housing 10 has an internal space and has a structure in which the top and bottom thereof are opened. More specifically, the housing 10 may include a first housing unit 11 housing the lens module 20 and a second housing unit 13 housing the image sensor module 30. The horizontal cross-sectional area of the first housing unit 11 may be smaller than that of the second housing unit 13.

The lens module 20 is received in the internal space of the first housing unit 11. The lens module 20 may be directly inserted into the first housing unit 11 in the state in which the stopping part 25, the first lens 21, and the second lens 22 are coupled to each other, or the lens barrel housing the stopping part 25, the first lens 21, and the second lens 22 may be inserted along the inner surface of the first housing unit 11.

The housing 10 may include a capping unit 12 bent in the first housing unit 11 to cover the flange unit 21b of the first lens 21 of the lens module 20 and a portion of the stopping part 25.

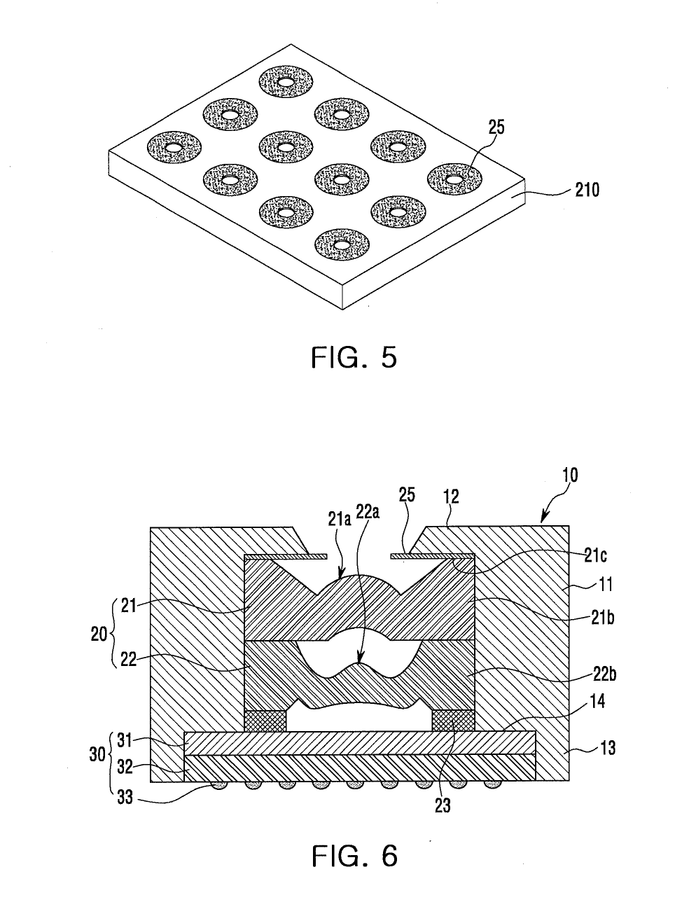

Hereinafter, referring to FIGS. 4 and 5, a method of manufacturing the lens module according to the first embodiment of the present invention on a wafer level will be described.

FIG. 4 is a perspective view of a lens wafer according to the first embodiment of the present invention and FIG. 5 is a perspective view of a lens wafer module according to the first embodiment of the present invention

Referring to FIG. 4, in a lens wafer 210 according to the first embodiment of the present invention, a plurality of lenses are arranged. Each lens includes a lens functioning unit 211 and a flange unit 212 forming a margin portion of the lens functioning unit 211. Only the lens wafer in which the stopping part is installed is disclosed in the present embodiment, but at least one sheet of lens wafer without the stopping part may be prepared.

A seating groove 213 is recessed in one surface of the lens wafer 210 such that the stopping part 25 is installed therein.

Referring to FIG. 5, the lens wafer module according to the first embodiment of the present invention includes the lens wafer 210, and the stopping part 25 installed in the seating groove 213 formed in the lens wafer 210 and blocking unnecessary light incident on the lens wafer 210. The stopping part 25 may have a circular ring shape.

When the lens wafer module is cut along a dicing line DL while the stopping part 25 is installed in the lens wafer, individual lenses having the respective stopping parts may be formed.

A method of manufacturing the lens module according to the first embodiment of the present invention on the wafer level will be described below.

As shown in FIG. 4, the lens wafer 210 is prepared in which the plurality of lenses each having the lens functioning unit 211, the flange unit 212, the seating groove are arranged. The lens wafer 210 may be manufactured on a wafer scale by stamping a resin using a stamp having a reversed shape corresponding to the shape of the lens wafer 210 and compressing and curing the resin.

Next, as shown in FIG. 5, the stopping part 25 is fixedly inserted into the seating groove 213 of each lens. The stopping part 25 may be fixed by applying a thermosetting adhesive such as epoxy to the seating groove 213.

When the lens wafer having the stopping part 25 installed therein is cut along the dicing line DL, individual lenses having the respective stopping parts may be formed.

Although the method of manufacturing the lens having the stopping part on the wafer level are shown in the present embodiment, the present invention is not limited thereto. It is apparent that a lens module in which the plurality of lenses are stacked on the optical axis can be manufactured on the wafer level. That is, when an additional lens wafer is manufactured and stacked on the top or bottom of the lens wafer having the stopping part along the optical axis, they are cut to thereby manufacture a lens module having two or more lenses.

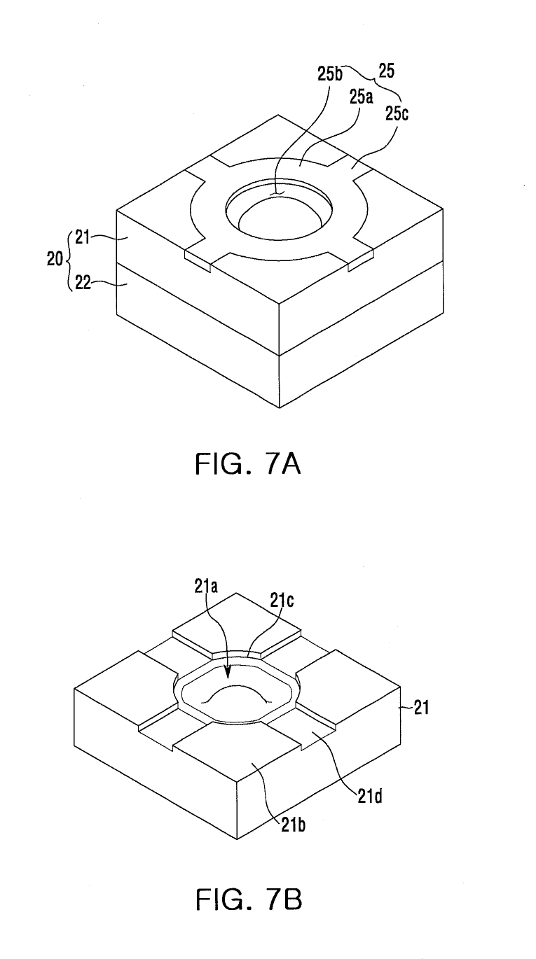

FIG. 6 is a schematic cross-sectional view showing the configuration of a camera module package including a lens module according to a second embodiment of the present invention. FIG. 7A is a perspective view of the lens module according to the second embodiment of the present invention, and FIG. 7B is a perspective view of a lens in the lens module according to the second embodiment of the present invention.

The lens module according to the second embodiment of the present invention shown in FIGS. 6 and 7 relates to a modified example of the stopping part. Since other configurations are the same as those of the lens module according to the first embodiment of the present invention shown in FIGS. 1 through 3, a detailed description thereof will be omitted and hereinafter, a difference therebetween will be primarily described.

Referring to FIG. 6, the camera module package according to the second embodiment of the present invention includes a lens module 20 including at least one lens stacked on an optical axis, an image sensor module 30 receiving light incident from the lens, and a housing 10 housing the lens module 20 and the image sensor module 30.

Referring to FIG. 7A, the lens module 20 includes a first lens 21 and a second lens 22 sequentially formed from an object side to an image side. A stopping part 25 blocking unnecessary light incident on the lens module 20 is installed on the top of the first lens 21, specifically, the top of the flange unit 21b of the first lens 21.

The stopping part 25 includes a light blocking unit 25a blocking unnecessary light incident on the lens module 20, an opening 25b allowing light to pass therethrough at the center thereof, and a bridge 25c extending from an outer diameter of the light blocking unit 25a to an outer part of the first lens 21. The light blocking unit 25a which is a circular ring part of the stopping part 25 and the bridge 25c may be integrally formed with each other.

In the present embodiment, four bridges 25c are formed on the surface of the stopping part 25 at an interval of 90 degrees therebetween, but the present invention is not limited thereto. Four or more or four or less bridges may be formed at regular or irregular intervals, that is, various design changes can be made.

Referring to FIG. 7B, the flange unit 21b of the first lens 21 includes a seating groove 21c in which the light blocking unit 25a of the stopping part 25 is seated and an extension groove 21d extending from an outer diameter of the seating groove 21c to the outer part of the first lens to allow the bridge 25c of the stopping part 25 to be seated therein.

In manufacturing the lens wafer in which the plurality of lenses are arranged, in order to install the stopping parts in the lens wafer in a single process, rather than separately installing them in individual lenses, the stopping parts may be implemented by connecting the light blocking units through the bridges. Accordingly, a sheet of stopping parts may be installed on the lens wafer and thereafter, the stopping parts may be diced and individualized for each lens unit, thereby simplifying a manufacturing process.

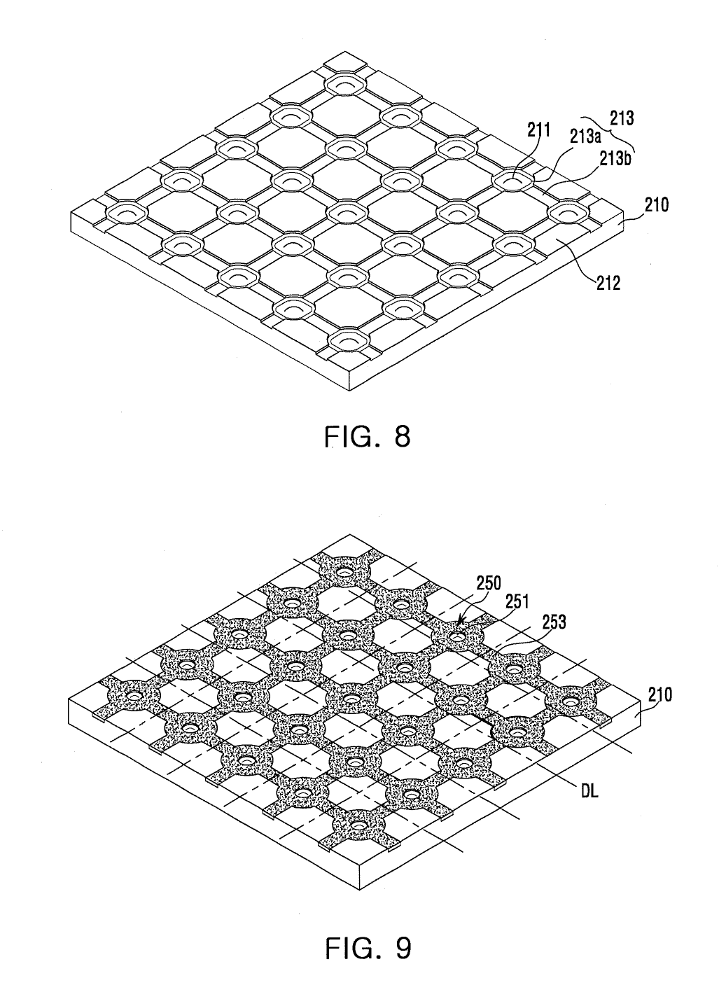

This type of lens wafer is shown in FIGS. 8 and 9. FIG. 8 is a perspective view of a lens wafer according to the second embodiment of the present invention, and FIG. 9 is a perspective view of a lens wafer module according to the second embodiment of the present invention.

Referring to FIG. 8, the plurality of lenses are arranged in the lens wafer 210 according to the second embodiment of the present invention, and each lens includes a lens functioning unit 211 and a flange unit 212 forming a margin portion of the lens functioning unit 211.

A seating groove 213 is recessed in one surface of the lens wafer 210 such that a stopping part 250 is installed therein. The seating groove 213 includes a first seating groove 213a in which a light blocking unit 251 of the stopping part 250 is seated and a second seating groove (extension groove) 213b in which a bridge 253 connecting the light blocking units of the individual lenses is seated.

Referring to FIG. 9, the lens wafer module according to the second embodiment of the present invention includes the lens wafer 210 and the stopping parts 250 installed in the seating grooves 213 formed in the lens wafer 210 to block unnecessary light incident on the lens wafer 210.

In the stopping parts 250, the light blocking units 251 and the bridges 253 are integrally formed with each other. When the stopping parts are cut along the dicing line DL in the lens wafer module according to the present embodiment, individual lens modules may be formed.

Although the lens wafer module in which the stopping part is installed in a single sheet of lens wafer is described in the present embodiment, a lens wafer module, in which two or more sheets of lens wafer are stacked on the optical axis and the stopping part is installed on a surface between the lens wafers, the upper surface of the object-side lens wafer, or the lower surface of the image-side lens wafer, is manufactured and cut along the dicing line such that individual lens modules may be formed.

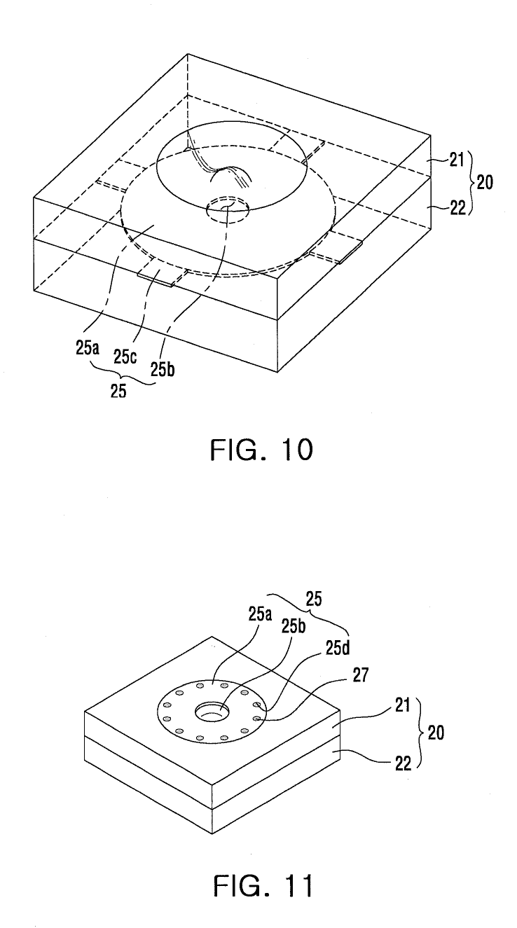

FIG. 10 is a perspective view of a lens module according to a third embodiment of the present invention.

The lens module according to the third embodiment of the present invention shown in FIG. 10 relates to a modified example of a stopping part whose position is changed. Since other configurations are the same as those of the lens module according to the second embodiment of the present invention shown in FIG. 7, a detailed description thereof will be omitted and hereinafter, a difference therebetween will be primarily described.

Referring to FIG. 10, the lens module 20 according to the third embodiment of the present invention includes a first lens 21 and a second lens 22 sequentially formed from an object side to an image side. A stopping part 25 blocking unnecessary light incident on the lens module 20 is installed on a surface between the first lens 21 and the second lens, specifically, on the top of the flange unit 22b of the second lens 22.

The stopping part 25 includes a light blocking unit 25a blocking unnecessary light incident on the lens module 20, an opening 25b allowing light to pass therethrough at the center thereof, and a bridge 25c extending from an outer diameter of the light blocking unit 25a to the outer part of the first lens 22. The light blocking unit 25a which is a circular ring part of the stopping part 25 and the bridge 25c may be integrally formed with each other.

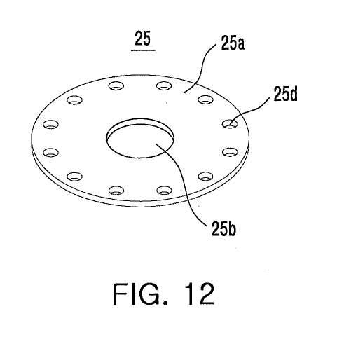

FIG. 11 is a perspective view of a lens module according to a fourth embodiment of the present invention, and FIG. 12 is a perspective view of a stopping part of the lens module according to the fourth embodiment of the present invention.

The lens module according to the fourth embodiment of the present invention shown in FIGS. 11 and 12 relates to a modified example of the stopping part. Since other configurations are the same as those of the lens module according to the first embodiment of the present invention shown in FIG. 3, a detailed description thereof will be omitted and hereinafter, a difference therebetween will be primarily described.

Referring to FIGS. 11 and 12, the lens module 20 according to the fourth embodiment of the present invention includes a first lens 21 and a second lens 22 sequentially formed from an object side to an image side. A stopping part 25 blocking unnecessary light incident on the lens module 20 is installed on an image-side surface of the first lens 21.

The stopping part 25 includes a light blocking unit 25a blocking unnecessary light incident on the lens module 20, an opening 25b allowing light to pass therethrough at the center thereof, and an adhesive unit 25d which is filled with an adhesive 27 at the time of fixing the stopping part 25.

The adhesive unit 25d may be formed on an outer-diameter side of the stopping part corresponding to the seating groove of the first lens 21 in which the stopping part 25 is installed. The plurality of adhesive units 25d may be formed along the outer diameter of the stopping part 25. For example, the adhesive units 25d may be formed at various regular intervals such as 180 degrees, 90 degrees, 60 degrees, 45 degrees or the like or at irregular intervals.

Although the adhesive unit 25d is a hole type unit having holes penetrating the stopping part 25 in a thickness direction, the present invention is not limited thereto. Any adhesive unit may be adopted so long as it may be filled with the adhesive to be applied to the seating groove. For example, the adhesive unit 25d may be a groove type unit recessed in the thickness direction of the stopping part 25.

The adhesive unit 25d may be filled with the adhesive 27 for fixing the stopping part 25. Specifically, when the adhesive 27 is applied to the seating groove of the first lens 21 and the stopping part 25 is inserted into the seating groove of the first lens 21, the adhesive applied to the seating groove fills the adhesive unit 25d. Therefore, the adhesion of the stopping part 25 may be performed through a surface facing the seating groove of the stopping part 25 and the adhesive unit 25d. In this case, the adhesive may be a thermosetting adhesive such as epoxy.

As described above, since the adhesive unit filled with the adhesive for fixing the stopping part 25 is additionally formed in the stopping part 25 in the present embodiment, the adhesive applied to the seating groove is filled in even the adhesive unit 25d to thereby fix the stopping part 25 more securely.

As set forth above, according to the embodiments of the present invention, a lens module and a lens wafer module can ensure the positional precision of a stopping part, blocking unnecessary light incident through a lens, whereby lens performance can be improved.

While the present invention has been shown and described in connection with the exemplary embodiments, it will be apparent to those skilled in the art that modifications and variations can be made without departing from the spirit and scope of the invention as defined by the appended claims. For example, the position and shape of the stopping part may be exemplified in the embodiments of the present invention, and they can be modified in various configurations. Accordingly, the scope of the present invention will be determined by the appended claims.

What is claimed is:

1. A lens module comprising:
a lens assembly including at least one lens stacked on an optical axis and a seating groove recessed in one surface of the lens; and
a stopping part installed in the seating groove and blocking unnecessary light incident on the lens assembly.

2. The lens module of claim 1, wherein the seating groove has a depth substantially identical to a thickness of the stopping part.

3. The lens module of claim 1, wherein the stopping part has a ring shape including an opening in a center thereof, the opening allowing light to pass therethrough.

4. The lens module of claim 1, wherein the at least one lens includes a lens functioning unit and a flange unit forming a margin portion of the lens functioning unit.

5. The lens module of claim 4, wherein the seating groove is stepped from one surface of the flange unit.

6. The lens module of claim 1, wherein the stopping part includes at least one bridge extending from an outer diameter thereof to an outer part of the at least one lens.

7. The lens module of claim 6, wherein the seating groove includes an extension groove extending from the outer diameter of the stopping part to the outer part of the at least one lens to allow the at least one bridge to be installed therein.

8. The lens module of claim 1, wherein the stopping part is installed in a seating groove formed in an upper surface of an object-side lens among the at least one lens.

9. The lens module of claim 1, wherein the stopping part is installed in a seating groove formed in an upper surface of an image-side lens among the at least one lens.

10. The lens module of claim 1, wherein the stopping part includes an adhesive unit along an outer diamter thereof, the adhesive unit being filled with an adhesive for fixing the stopping part.

11. A lens wafer module comprising:
a lens wafer in which a plurality of lenses are arranged; and
stopping parts installed in seating grooves recessed in one surface of the lens wafer, and including light blocking units blocking unnecessary light incident on the lenses and bridges making connections between the light blocking units of the individual lenses.

12. The lens wafer module of claim 11, wherein each of the plurality of lenses includes a lens functioning unit and a flange unit forming a margin portion of the lens functioning unit.

13. The lens wafer module of claim 12, wherein the seating groove is stepped from one surface of the flange unit.

14. A method of manufacturing a lens module, the method comprising:
preparing a lens wafer in which a plurality of lenses are arranged;
installing stopping parts blocking unnecessary light incident on the lenses in seating grooves recessed in one surface of the lens wafer; and
cutting the lens wafer having the stopping parts installed therein into the individual lenses.

15. The method of claim 14, wherein the installing of the stopping parts in the seating grooves of the lens wafer is performed by separately installing the individual stopping parts in the respective lenses.

16. The method of claim 14, wherein the installing of the stopping parts in the seating grooves of the lens wafer is performed by installing a single sheet of the stopping parts including light blocking units and bridges connecting the light blocking units in the respective lenses.
